(19) United States
(12) Patent Application Publication
(10) Pub. No.: US 2010/0299342 A1
(43) Pub. Date: Nov. 25, 2010

(54) SYSTEM AND METHOD FOR MODIFICATION IN COMPUTERIZED SEARCHING

(75) Inventors: Steven Matt Gustafson, Schenectady, NY (US); Samit Paul, Karnataka (IN); Babu Ozhur Narayanan, Karnataka (IN); Vineel Chandrakanth Gujjar, Karnataka (IN)

Correspondence Address: FLETCHER YODER P.C., 7915 FM 1960 RD. WEST, SUITE 330, HOUSTON, TX, 77070, US

(73) Assignee: NBC Universal, Inc., New York, NY (US)

(21) Appl. No.: 12/471,115

(22) Filed: May 22, 2009

(51) Int. Cl. G06F 17/30; G06N 5/02

(52) U.S. Cl. 707/759; 706/50; 707/769; 707/713

(57) ABSTRACT

A system and method for conducting a computerized search, including: receiving a query from a user; classifying the query; augmenting the query based on the classification; issuing the query to a search engine; and conducting a search based on the augmented query. Alternatively, a system and method for conducting a computerized search, including: receiving a search query; analyzing a knowledge base; modifying the search query based on the analysis of the knowledge base; issuing the modified search query to a search engine; and conducting a search via the search engine based on the modified search query to generate search results.

### BACKGROUND

The present invention relates generally to the field of computerized searching, and more particularly for providing computerized search results relevant to a given community.

Computerized searching via the Internet or Web, such as with Google™ or Yahoo!®, has become a daily activity for many. Such searches may be conducted for personal or business reasons. Unfortunately, some of the search results may not be relevant to the particular user.

### BRIEF DESCRIPTION

An aspect of the invention includes a method for conducting a computerized search, including: receiving at a query from a user; classifying the query; augmenting the query based on the classification; issuing the query to a search engine; and conducting a search based on the augmented query.

An aspect of the invention includes a method for conducting a computerized search, including: receiving a search query; analyzing a knowledge base; modifying the search query based on the analysis of the knowledge base; issuing the modified search query to a search engine; and conducting a search based on the modified search query to generate search results.

An aspect of the invention includes a system for conducting a computerized search, including: a classifier configured to classify a user search query for augmentation; a first augmenter module configured to receive a user search query from the classifier and to augment the user search query; a second augmenter module configured to receive a user search query from the classifier to augment a user search query; and an engine module configured to issue an augmented user search query to a search engine from at least one of the first augmenter module or the second augmenter module.

An aspect of the invention includes a system for conducting a computerized search, including: a server comprising executable code stored in memory, wherein the executable code is configured to: receive a search query; analyze a knowledge base; modify the search query based on the analysis of the knowledge base; issue the modified search query to a search engine; and to conduct a search via the search engine based on the modified search query.

### DRAWINGS

These and other features, aspects, and advantages of the present invention will become better understood when the following detailed description is read with reference to the accompanying drawings in which like characters represent like parts throughout the drawings, wherein:

FIG. 1 is diagrammatical representation of a system for conducting a computerized search in accordance with aspects of the present invention;

FIG. 2 is a block diagram of a method for conducting a computerized search in accordance with aspects of the present invention; and

FIG. 3 is a block diagram of a method for conducting a computerized search in accordance with aspects of the present invention.

### DETAILED DESCRIPTION

The quality of web search experience can be improved by refining the search terms or search results based on the context in which user is conducting the search. For instance, a search for the term “labor” by a woman may be more refer to “pregnancy” than “labor union” (politics) or “unemployment.” In implementation, the present technique may encompass a divide-and-conquer strategy for refining the query. In certain embodiments, the input search query may be categorized in at least three categories or classes: (1) Word Sense Disambiguation Queries are those queries which have more that one synonym, some of which are more relevant to the user conducting the query; (2) Perspective Queries are those wherein the expected results of the query is different for different types of users (e.g., a woman search the term “shoes” might expect results corresponding to “shoes for females”); (3) Default Queries are those queries wherein there is not particular result refinement required for the user. As discussed below, each of the above three categories may have a Query Augmenter module associated with it. Once the query is classified, it may be forwarded to the corresponding Query Augmenter module for handling. The selected query augmenter module may augment the query with additional keyword terms. The augmented query may then be submitted to a regular search engine and the results returned to the user. The technique may improve the search quality of a given community of users. This can in turn increase the popularity of the search product and greater revenues can be generated by increased traffic with click-through advertisements and banner advertisements, for example. It should be noted that a given community may be defined or encompass a variety of formats. For example, a community may be visitors to a given web site (e.g., ivillage.com), visitors to a personal website (e.g., Linekdin or Facebook), readers on a particular blog, or any implicitly defined community, and so on.

The product can offer web search services for a targeted community of users. Thereby the product has an edge over conventional search engines which are mostly targeted for general users. Again, the popularity of the product can be converted to revenues by means of click-through advertisements and banner advertisements. A novelty of the technique is that queries may be categorized and the augmented based on the category in which the query falls.

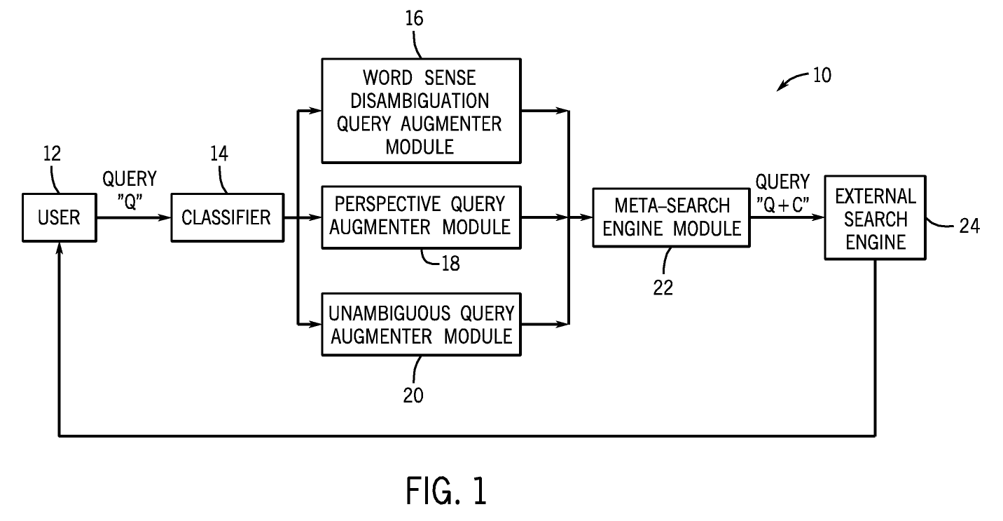

Referring to the drawings, FIG. 1 depicts a system 10 for conducting a computerized search. The system 10 may be implemented on a computer or server having executable code stored in memory, for example. In the system 10, a query is received from a user 12 to a classifier 14. In the illustrated embodiment, the classifier 14 classifies the query into one of three categories and forwards the query to the appropriate augmenter module 16, 18, or 20. It should be emphasized that the number of categories and associated augmenter modules 16, 18, or 20 may encompass less than three or more than three The word sense disambiguation augmenter module 18 and the perspective query augmenter module 18 augments the query, such as by adding an additional word to the query. Again, the word sense disambiguation queries may be those queries which have more that one synonym, some of which are more relevant to the user conducting the query. Determination of word sense disambiguation may be performed with a thesaurus, such as Wordnet, in conjunction with analysis of results from a knowledge base (e.g., from an internal search on a specific web site such as ivillage.com). Perspective queries may be those wherein the expected search results of the query vary for different types of users. The query can be classified as “broad”, “specific” or “sexual”, and so on, by suitable analysis. The unambiguous query augmenter module 20 does not modify the query but instead passes the default query unaffected. To perform the search, a meta-search engine module 22 submits or issues the modified query (or unmodified query) to a search engine 24, such as a conventional search engine. The conventional search engine generates the search results (based on the query received from the engine module 22) as per its algorithm, for example. Search results generated may be supplied from the search engine 24 back to the user.

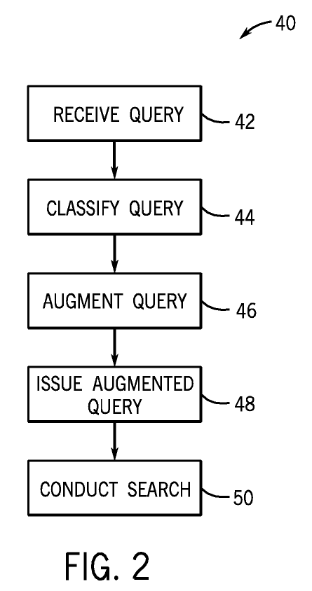

FIG. 2 depicts a method 40 for conducting a computerized search. Initially, a query is received (block 42) from a user, for example. The query is then classified (block 44). As indicated, exemplary categories for classification include: (1) word sense disambiguation; (2) perspective; and (3) unambiguous. The query is then augmented based on the classification (block 46). Augmentation may involve adding one or more words to the query. As mentioned, the query may not be augmented for those instances, such as with the unambiguous category, where there is not a particular result refinement required or beneficial for the user. The augmented query or unchanged query may be automatically submitted or issued (block 48) to a search engine, for example, as a query for a search. Finally, the search may be conducted based on the augmented query or unchanged query (block 50). It should be noted that all elements of the method may be conducted automatically without user intervention.

In other aspects, the present technique may provide the general user with the ability to conduct general Internet searches from the perspective of a knowledge base or database. For example, information indexed by search engines on the Internet can be characterized as at least two forms: information meant for the layman, and information meant for the professional. Within a given domain, such as a medical domain, the general user has the ability using known terms to search and retrieve information indexed in databases for the layman. However, the present technique may give the general user the ability to retrieve information indexed in databases for the professional, for example, by mapping their query into the appropriate professional terms and keywords and expanding it with appropriate relevant keywords and concepts. The present technique uses a knowledge base, or set of documents, to map and expand a search query to be performed over the Internet, which may or may not include the documents forming that knowledge base.

Certain embodiments may have several features to address the problem of enabling the general user to perform a search query from the perspective of the knowledge base. Again, employment of the knowledge base maps and/or expands the original search query. The knowledge base could be offline, proprietary, or other data that represents the target perspective. Further, a statistical approach may decide to map and/or expand a search query when the knowledge base has enough “support” for that mapping and/or expansion, for example. Moreover, the technique may employ the general approach of mapping a search query into new keywords or terms from the knowledge base, as well as the general approach of expanding a search query with related keywords or terms to the original or mapped query. Lastly, a search engine specific approach may be utilized to perform the mapping and expansion of the original search query to increase relevance based on the performance of a specific search engine.

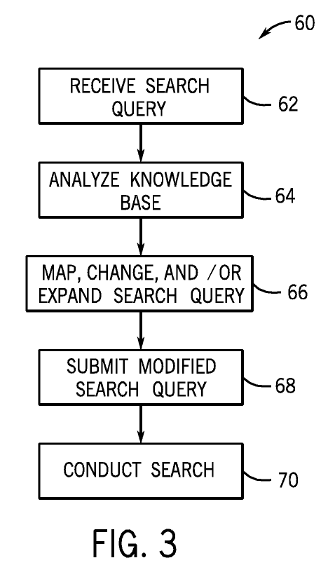

FIG. 3 depicts a method 60 for conducting a computerized search. A search query is received (block 62) from a user, for example. A knowledge base is analyzed (block 64). The search query is then mapped, changed, and/or expanded based on the analysis of the knowledge base (block 66). It should be noted that embodiments of the present technique differ from contextual search engines in that the present technique may rely upon a specific set of documents (i.e., knowledge base), to map and/or expand a search query for searching within another set of documents that may or may not contain the knowledge base. The present technique may treat the knowledge base as the default “context” of the search query. After mapping and/or expanding the search query based on the knowledge base, a new search query may be submitted to another search engine (block 68), thereby giving bias to the knowledge-base (subset of documents). A search is then conducted based on the modified query (block 70). It should be noted that the computer searches discussed herein may be conducted from a personal computer, mobile computer or laptop, personal digital assistant (PDA), cell phone, other appliances, and so on.

In sum, the technique makes novel use of the set of documents comprising the knowledge base. The technique employs a knowledge base to map and/or expand a search query for submission to another search engine to provide the user the ability to search with the perspective of the knowledge base. This may be in contrast to providing enhanced search over a set of documents based on that set of documents, or with the assistance of a very small user submitted set of keyword or terms which are either used to expand the query or are themselves filtered by the same set of documents prior to expanding the search query.

Further, the technique may be employed as a part or component of an integrated product. The technique concerns the mapping and/or expansion of a general search query based on a knowledge base for a specific search engine. The product may also contain a system and method to produce the knowledge base, to interface to a specific search engine, to adjust the result set from the specific search engine after submitting the new mapped and/or expanding query, and so on.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for conducting a computerized search, comprising:
receiving at a processor a query from a user;
classifying the query via the processor;
augmenting the query via the processor based on the classification;
issuing the query to a search engine via the processor; and
conducting a search based on the augmented query via the search engine.

2. The method of claim 1, comprising returning results of the search to the user via the processor.

3. The method of claim 1, wherein classifying comprises classifying the query into a word sense disambiguation category.

4. The method of claim 3, wherein classifying comprises classifying the query via use of a thesaurus and a knowledge base.

5. The method of claim 1, wherein classifying comprises classifying the query into a perspective category.

6. The method of claim 5, wherein classifying classifying the query via analysis of a knowledge base.

7. The method of claim 1, wherein augmenting comprises adding at least one additional word to the query.

8. A method for conducting a computerized search, comprising:
receiving a search query at a processor;
analyzing a knowledge base via the processor;
modifying the search query via the processor based on the analysis of the knowledge base;
issuing the modified search query to a search engine via the processor; and
conducting a search via the search engine based on the modified search query to generate search results.

9. The method of claim 8, wherein modifying the search query comprises adding a word to the search query.

10. The method of claim 8, wherein modifying the search query comprises mapping and expanding the search query.

11. The method of claim 8, wherein analyzing the knowledge base comprises analyzing the knowledge base with respect to the search query.

12. The method of claim 8, wherein the knowledge base comprises a set of documents.

13. The method of claim 12, wherein the set of documents at least partially differs from information searched via the search engine.

14. The method of claim 8, wherein the knowledge base provides a default context of the search query.

15. The method of claim 8, wherein modifying the search query comprises modifying the search query such that the search results are biased toward the knowledge base.

16. The method of claim 8, wherein the knowledge base comprises an off-line knowledge base not available on the Internet.

17. The method of claim 8, wherein the search results are not filtered.

18. A system for conducting a computerized search, comprising:
a classifier configured to classify a user search query for augmentation;
a first augmenter module configured to receive a user search query from the classifier and to augment the user search query;
a second augmenter module configured to receive a user search query from the classifier to augment a user search query; and
an engine module configured to issue an augmented user search query to a search engine from at least one of the first augmenter module or the second augmenter module.

19. The system of claim 18, wherein the classifier is configured to classify the user search query based on word sense disambiguation for augmentation in the first augmenter module.

20. The system of claim 18, wherein the first augmenter module provides augmented user query that is a word sense disambiguation query.

21. The system of claim 18, wherein the classifier is configured to classify the user search query based on a perspective for augmentation in the second augmenter module.

22. The system of claim 18, wherein the first augmenter module provides augmented user query that is a perspective query.

23. The system of claim 18, wherein the enginer module comprises a meta-search engine module.

24. The system of claim 18, comprising a default query module configured to pass the user search query from the classifier to the engine module without augmentation.

25. A system for conducting a computerized search, comprising:
a server comprising executable code stored in memory, wherein the executable code is configured to:
receive a search query;
analyze a knowledge base;
modify the search query based on the analysis of the knowledge base;
issue the modified search query to a search engine; and
to conduct a search via the search engine based on the modified search query.
